(19) United States
(12) Patent Application Publication
(10) Pub. No.: US 2021/0214202 A1
(43) Pub. Date: Jul. 15, 2021

(54) LIFT TRUCK

(71) Applicant: TOYOTA MATERIAL HANDLING MANUFACTURING ITALY S.P.A., Bologna (IT)

(72) Inventors: Simone FREMONDI, Bologna (IT); Andrea GENNARI, Monticelli Terme (Parma) (IT)

(21) Appl. No.: 17/146,982

(22) Filed: Jan. 12, 2021

(30) Foreign Application Priority Data
Jan. 13, 2020 (IT) 102020000000397

(51) Int. Cl. B66F 9/20; B66F 9/075; G05G 1/01; G05G 9/047

(52) U.S. Cl. CPC B66F 9/20; B66F 9/0759; G05G 2009/04703; G05G 9/047; G05G 1/01

(57) ABSTRACT

Described is a lift truck comprising an upright device which comprises at least one actuator unit configured for moving at least one element for moving a load;
an armrest having a plurality of control levers, each configured for controlling a respective actuator unit by means of a relative movement of the control lever;
the armrest comprises a first supporting element configured for resting the forearm of the driver of the truck and a second supporting element configured for resting the palm of the hand of the driver;
the second supporting element is positioned in a portion of the armrest between the control levers and the first supporting element;
the second supporting element is configured to vibrate to signal to the driver that predetermined operating conditions of the truck have been reached.

This application claims priority to Italian Patent Application 102020000000397 filed Jan. 13, 2020, the entirety of which is incorporated by reference herein.

### BACKGROUND OF THE INVENTION

This invention relates to a lift truck.

### SUMMARY OF THE INVENTION

The lift truck comprises an upright device configured for moving a load.

The upright device comprises at least one actuator of a load movement element, which may be, for example, in the form of forks, drum rotators, telescopic arms, grippers.

In order to be able to control the movement of the truck and the actuation of the load movement element, the truck comprises an armrest having a plurality of control levers, each configured to control a respective actuator unit.

The armrest supports the forearm of the driver in such a way that the control levers can be actuated by the fingers of the hand whilst driving the truck.

In this context, the need has been felt of implementing the armrest of the truck with a vibrating element configured to confirm correct manual activations of the driver or as a signaling of certain operating conditions of the truck, as described in independent claim 1.

Advantageously, the vibration makes it possible to provide the driver with a touch-type consent which, with respect to a single optical signal, does not distract the driver from the driving.

Advantageously, a touch-type consent improves the efficiency of the work of the driver who, whilst performing an activity, is not required to visually check luminous signals or the display for controlling the truck.

### BRIEF DESCRIPTION OF THE DRAWINGS

Further features and advantages of the invention are more apparent from the non-limiting description which follows of a preferred embodiment of a lift truck as illustrated in the accompanying drawings, in which:

FIG. 1 is a schematic view of a lift truck according to this invention;

FIG. 2 illustrates a detail of FIG. 1 according to a first variant embodiment;

FIG. 3 is a schematic perspective view of an armrest of the lift truck.

### DESCRIPTION OF THE PREFERRED EMBODIMENTS

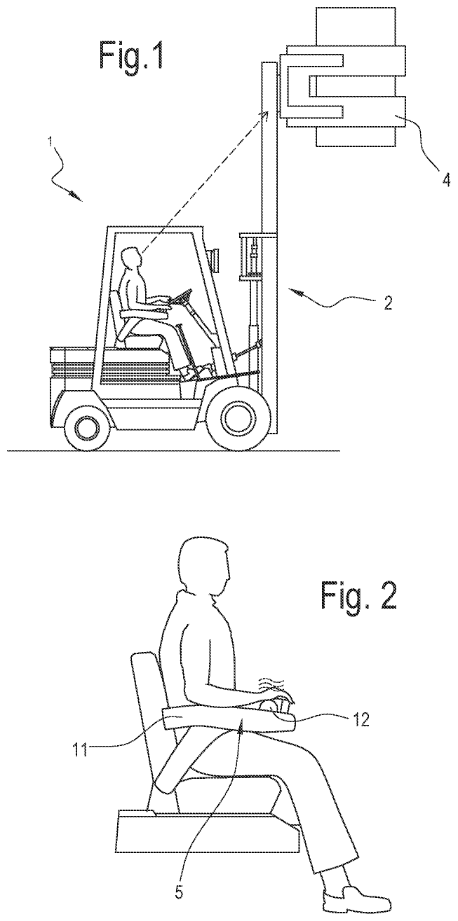

The reference numeral 1 in FIG. 1 denotes a lift truck according to the invention.

The lift truck 1 comprises an upright device 2 configured for moving a load.

The upright device comprises at least one actuator unit 3 of a load movement element 4, which may be in the form, for example, of forks, drum rotators, telescopic arms, grippers.

The truck 1 comprises an armrest 5 having a plurality of control levers 6, 7, 8, 9 each configured for being moved relative to the armrest 5.

The relative movement of each control lever 6, 7, 8, 9 with respect to the armrest 5 causes actuation of a respective command to an actuator unit 3.

At least one of the control levers 6, 7, 8, 9 is configured to control the actuator unit 3 of a movement element 4.

For example, the movement element 4 is in the form of grippers.

In particular, each control lever 6, 7, 8, 9 is configured to be actuated by a respective finger of the hand.

In particular, the armrest 5 has a first lever 6, a second lever 7, a third lever 8, a fourth lever 9.

According to a preferred configuration, the first lever 6 can be operated by the index finger, the second lever 7 can be operated by the middle finger, the third lever 8 can be operated by the ring finger and the fourth lever 9 can be operated by the little finger.

The armrest 5 is configured to support the forearm of the driver in such a way that the control levers 6, 7, 8, 9 can be actuated by the fingers of the hand, whilst driving the truck 1.

In particular, the armrest 5 comprises a first supporting element 11 configured for resting the forearm of the driver of the truck 1 and a second supporting element 12 configured for resting the palm of the hand of the driver.

The second supporting element 12 is positioned in a portion 5a of the armrest 5 between the control levers 6, 7, 8, 9 and the first supporting element 11.

In order to be able to adjust the relative position between the second supporting element 12 and the control levers 6, 7, 8, 9, according to the ergonomics of the driver's hand, the second supporting element 12 is movable along a longitudinal direction of the armrest 5.

The second supporting element 12 has at least one element 13 for activating at least one of the control levers 6, 7, 8, 9, in particular and preferably the fourth lever 9.

The activation of the activating element 13 by the driver causes the passage from a first control condition to a second control condition of at least one of the control levers 6, 7, 8, 9, for example the fourth lever 9.

The expressions first control condition and second control condition mean an operating condition such that the relative movement of a control lever 6, 7, 8, 9 results in a respective first actuation and second actuation, different from the first actuation. By way of example, with reference to at least one control lever 6, 7, 8, 9, in particular the fourth lever 9, it means that the passage from a first control condition to a second control condition causes the activation of a respective actuator unit 3.

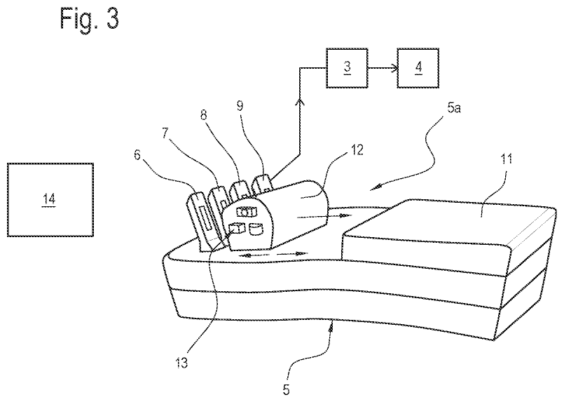

It should be noted that, preferably, the activating element 13 is positioned in such a way that it can be actuated by the thumb of the hand, see FIG. 3.

According to the invention, at least one portion of at least one of either the first supporting element 11 or the second supporting element 12 is configured to vibrate following activation of the activating element 13 by the driver, in order to confirm that the activating element 13 has been actuated.

According to the preferred embodiment, the second supporting element 12 is configured for vibrating, as schematically illustrated in FIG. 2.

Alternatively, the first supporting element 11 is configured to vibrate both the first supporting element 11 and the second supporting element 12, as schematically illustrated in FIG. 3.

The touch confirmation signaling by the second supporting element 12 is very important if the driver must be certain of being able to act on the control lever 9, in particular the fourth lever 9, which has passed from the first control condition to the second control position.

For example, the second control condition could occur if the driver has to activate the operation of the control lever 9 designed for actuating the actuator unit 3 designed for opening and closing the pick-up grippers 4 of the truck 1.

According to a further element, the second supporting element 12 is configured to vibrate if the movement element 4 reaches a predetermined height above ground, in particular close to the maximum height which can be reached by the movement element.

According to a further embodiment, the second supporting element 12 is configured to vibrate if the battery charge of the truck 1 is nearly flat.

In general, the second supporting element 12 is configured to vibrate to signal to the driver operating conditions of predetermined operating elements of the truck 1.

In fact, it should be noted that a touch-type signal allows the driver not to pay special attention to the optical signals of the truck 1, which might distract him/her from driving of the truck 1 or from activation of the control levers 6, 7, 8, 9.

The truck 1 comprises a display device 14, preferably in the form of a screen.

The display device 14 is configured to make visually available to the driver the activation of the vibration of the above-mentioned portion of armrest 5 upon further confirmation of the touch-type indication.

What is claimed is:

1. A lift truck comprising
an upright device which comprises at least one actuator unit configured for moving at least one element for moving a load;
an armrest comprising a first supporting element configured for resting the forearm of the driver of the truck and a second supporting element configured for resting the palm of the hand of the driver;
wherein at least a portion of at least one between the first supporting element and the second supporting element is configured to vibrate to signal to the driver that predetermined operating conditions of the truck have been reached.

2. The truck according to claim 1, wherein the armrest has a plurality of control levers, at least one control lever being configured to drive a respective actuator unit by a relative movement of the control lever; at least one between the first supporting element and the second supporting element is configured to vibrate following operation of an activating element configured to control the passage from a first control condition to a second control condition of at least one of the control levers.

3. The truck according to claim 2, wherein the second supporting element has the activating element; in particular, the activating element being positioned in such a way as to be actuated by the thumb of the hand.

4. The truck according to claim 1, wherein the second supporting element is configured to vibrate if the battery charge of the truck has run out.

5. The truck according to claim 1, wherein the second supporting element is configured to vibrate if the movement element reaches a predetermined height above ground, in particular close to the maximum height which can be reached by the movement element.

6. The truck according to claim 1, wherein the armrest has a plurality of control levers, each configured for controlling a respective actuator unit by means of a relative movement of the control lever; the second supporting element, positioned in a portion of the armrest between the control levers and the first supporting element, being configured to vary the relative position with respect to the control levers along a longitudinal direction of extension of the armrest in such a way as to position the second supporting element as a function of the ergonomics of the hand of the driver.

7. The truck according to claim 1, comprising a display device configured to make visually available to the driver the activation of the vibration of the above-mentioned portion of the armrest.
